(19) United States
(12) Patent Application Publication
(10) Pub. No.: US 2020/0023840 A1
(43) Pub. Date: Jan. 23, 2020

(54) DRIVER ASSISTANCE SYSTEM

(71) Applicant: Delphi Technologies, Inc., Troy, MI (US)

(72) Inventors: Ronald M. Taylor, Greentown, IN (US); Jeremy S. Green, McCordsville, IN (US); Suresh K. Chengalva, Westfield, IN (US); Nasser Lukmani, Frisco, TX (US)

(21) Appl. No.: 16/335,876

(22) PCT Filed: Oct. 18, 2017
(86) PCT No.: PCT/US2017/057119

§ 371 Date: Mar. 22, 2019

Related U.S. Application Data
(60) Provisional application No. 62/415,005, filed on Oct. 31, 2016.

(51) Int. Cl. B60W 30/095; B60W 50/14; G06K 9/00; G06T 7/246

(52) U.S. Cl. CPC B60W 30/0956; B60W 30/0953; B60W 50/14; G06K 9/00805; G06T 7/248; B60K 35/00; B60W 2050/143; B60W 2420/42; B60W 2550/10; B60W 2520/10; B60W 2050/146

(57) ABSTRACT

A driver assistance system includes an imaging device mounted to a vehicle that provides an image of a vicinity of the vehicle. A mobile device carried by a driver provides range rate information regarding a change in position of the mobile device. A processor determines that there is at least one object in the vicinity of the vehicle based on the image, determines the speed of vehicle movement based on the range rate information, determines relative movement between the vehicle and the at least one object based on at least the image, and determines a risk of collision between the vehicle and the at least one object based on the determined speed and the determined relative movement. A driver assist output provides a risk indication of the determined risk of collision to the driver.

### CROSS-REFERENCE TO RELATED APPLICATIONS

This application claims priority to PCT Patent Application Number PCT/US17/57119, filed Oct. 18, 2017, which claims priority to U.S. Provisional Application No. 62/415,005, which was filed on Oct. 31, 2016, and published as WO2018/080862 May 3, 2018. The entire disclosure of that provisional patent application is hereby into this document by reference.

### TECHNICAL FIELD

The subject matter of this document pertains to vehicle guidance systems. More particularly, and without limitation, the subject matter of this document pertains to a driver assistance system that utilizes range rate information from a mobile device and provides a collision risk indication to a driver.

### BACKGROUND

Innovations in electronics and technology have made it possible to incorporate a variety of advanced features on automotive vehicles. Various sensing technologies have been developed for detecting objects for monitoring the surroundings in a vicinity or pathway of a vehicle. Such systems are useful for parking assist, lane departure detection and cruise control adjustment features, for example.

While there is a desire to provide enhanced features on vehicles that does not come without cost. A variety of different types of detectors or sensors are needed for different driver-assist capabilities. The addition of each type of sensor introduces additional cost and a need for processing additional information on-board the vehicle. Retrofitting existing vehicles to enhance capabilities on them is particularly challenging. For example, it is difficult to retrofit a variety of different types of sensors onto a vehicle and then to incorporate those with on-board vehicle electronics.

Embodiments of this invention provide an ability to add enhanced driver assistance capability without requiring incorporating additional electronics into a vehicle.

### SUMMARY

An illustrative example embodiment of a driver assistance system includes an imaging device configured to be mounted to a vehicle and to provide an image of a vicinity of the vehicle. A mobile device is configured to be carried by a driver and has global position system (GPS) capability that provides at least an indication of range rate information regarding a change in position of the mobile device. A processor utilizes information regarding the image from the imaging device and the indication of range rate information from the mobile device. The processor determines that there is at least one object in the vicinity of the vehicle based on the image, determines the speed of vehicle movement based on the range rate information, determines relative movement between the vehicle and the at least one object based on at least the image, and determines a risk of collision between the vehicle and the at least one object based on the determined speed and the determined relative movement. A driver assist output provides a risk indication of the determined risk of collision to the driver.

In an example embodiment having one or more features of the driver assistance system of the previous paragraph, the driver assist output comprises a display screen, the display screen displays a representation of the image, and the display screen provides a visual representation of the risk indication.

In an example embodiment having one or more features of the driver assistance system of any of the previous paragraphs, the mobile device comprises the display screen.

In an example embodiment having one or more features of the driver assistance system of any of the previous paragraphs, the mobile device is configured with an application that allows the mobile device to receive the image from the imaging device and the mobile device comprises the processor.

In an example embodiment having one or more features of the driver assistance system of the previous paragraph, the mobile device comprises a cellular phone.

In an example embodiment having one or more features of the driver assistance system of any of the previous paragraphs, the mobile device is configured to provide an audible output of the risk indication.

An example embodiment having one or more features of the driver assistance system of any of the previous paragraphs includes a user interface configured to be supported in the vehicle and the user interface comprises the processor and the display screen.

In an example embodiment having one or more features of the driver assistance system of any of the previous paragraphs, the image indicates a condition of the vicinity behind the vehicle and the processor determines whether the vehicle is moving in a forward or reverse direction. If the vehicle is moving in the reverse direction, the processor determines a change in distance between the vehicle and the at least one object based on at least the determined speed of vehicle movement and a position of the at least one object in the image. If the vehicle is moving in a forward direction, the processor determines an intended pathway of the vehicle based on information from the image.

In an example embodiment having one or more features of the driver assistance system of any of the previous paragraphs, if the vehicle is moving in the forward direction, the processor determines an intended pathway of the vehicle based on at least information from the image, determines a trajectory of the vehicle relative to the intended pathway, and determines a risk that the vehicle will depart from the intended pathway based on the determined speed of vehicle movement and the determined trajectory. The driver assist output provides an indication to the driver regarding the determined risk that the vehicle will depart from the intended pathway.

In an example embodiment having one or more features of the driver assistance system of any of the previous paragraphs, the intended pathway comprises a marked travel lane on a roadway and the driver assist output provides a warning regarding the vehicle departing from the marked travel lane when the risk that the vehicle will depart from the intended pathway exists.

In an example embodiment having one or more features of the driver assistance system of any of the previous paragraphs, the imaging device comprises at least one of a visible image detector and a thermal image detector.

In an example embodiment having one or more features of the driver assistance system of any of the previous paragraphs, the image comprises a plurality of pixels, the processor determines the relative movement between the vehicle and the at least one object based on changes in a quantity of pixels between a first area of the image corresponding to the vehicle and a second area of the image corresponding to the at least one object, and the processor determines the risk of collision based on a current quantity of the pixels between the first and second areas of the image and the determined speed of vehicle movement.

An illustrative example embodiment of a method of assisting a driver of a vehicle includes obtaining an image of a vicinity of the vehicle; obtaining range rate information from a mobile device that has GPS compatibility and is configured to be carried by the driver, the mobile provides at least an indication of range rate information regarding a change in position of the mobile device; determining that there is at least one object in the vicinity of the vehicle based on the image; determining a speed of vehicle movement based on the range rate information; determining relative movement between the vehicle and the at least one object based on at least the image; determining a risk of collision between the vehicle and the at least one object based on the determined speed and the determined relative movement; and providing a risk indication of the determined risk of collision to the driver.

An example embodiment having one or more features of the method of the previous paragraph includes displaying a representation of the image on a display screen and providing the risk indication as a visible indication on the display screen.

In an example embodiment having one or more features of the method of either of the previous paragraphs, the mobile device comprises the display screen.

In an example embodiment having one or more features of the method of any of the previous paragraphs, the mobile device comprises a cellular phone.

In an example embodiment having one or more features of the method of any of the previous paragraphs, the mobile device is configured to provide an audible output of the risk indication.

In an example embodiment having one or more features of the method of any of the previous paragraphs, the image indicates a condition of a vicinity behind the vehicle and the method includes determining whether the vehicle is moving in a forward or reverse direction. If the vehicle is moving in the reverse direction, a change in distance between the vehicle and the at least one object is determined based on at least the determined speed of vehicle movement and a position of the at least one object in the image. If the vehicle is moving in the forward direction, an intended pathway of the vehicle is determined based on information from the image, a trajectory of the vehicle relative to the intended pathway is determined, a risk that the vehicle will depart from the intended pathway is determined based on the determined speed and the determined trajectory, and an indication is provided to the driver regarding the determined risk that the vehicle will depart from the intended pathway.

In an example embodiment having one or more features of the method of any of the previous paragraphs, the intended pathway comprises a marked travel lane on a roadway and the provided indication to the driver provides a warning regarding the vehicle departing from the marked travel lane when the risk that the vehicle will depart from the intended pathway exists.

In an example embodiment having one or more features of the method of any of the previous paragraphs, the image comprises a plurality of pixels and the method includes determining the relative movement between the vehicle and the at least one object based on changes in a quantity of pixels between a first area of the image corresponding to the vehicle and a second area of the image corresponding to the at least one object, and determining the risk of collision based on a current quantity of the pixels between the first and second areas of the image and the determined speed of vehicle movement.

Various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a driver assistance system designed according to an embodiment of this invention associated with an example vehicle.

FIG. 2 is a flowchart diagram summarizing an example method designed according to an embodiment of this invention.

FIG. 3 diagrammatically illustrates an example visual output provided on a display screen according to an embodiment of this invention.

### DETAILED DESCRIPTION

Embodiments of this invention provide a vehicle driver with enhanced guidance or information regarding a vicinity of the vehicle. For example, embodiments of this invention provide a driver with a collision risk indication while moving the vehicle in reverse.

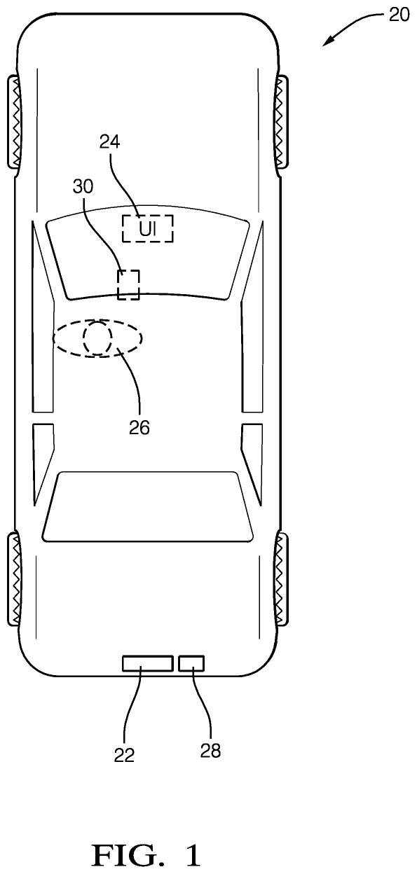

FIG. 1 schematically shows a vehicle with an associated driver assistance system 20 designed according to an embodiment of this invention. An imaging device 22 is mounted to the vehicle and provides an image of a vicinity of the vehicle, such as the area immediately behind the vehicle. In an example embodiment, the imaging device 22 comprises a camera that provides a visual image of the area in the vicinity of the vehicle 20 within the camera's field of view. The visual image may be a photographic image or video.

A user interface (UI) 24 is supported on the vehicle so that at least a driver output is available to a driver 26 of the vehicle 20. The driver output of the user interface 24 may comprise a display screen, an audio speaker, or both. In some embodiments the user interface 24 includes input features allowing the driver 26 to input information or make selections.

The illustrated example includes a thermal sensor or thermal camera 28 that provides an image of the area in the vicinity of the rear of the example vehicle 20. Such an image includes an indication of at least one object that is detected based upon the temperature of the object in the vicinity of the vehicle 20.

When the imaging device 22, 28 provides information from a visual camera 22 and thermal camera 28, the image information provided by the imaging device of the example driver assistance system 20 incorporates information available from both types of cameras for detecting at least one object near the vehicle.

A mobile device 30 is configured to be carried by the driver 26. In some example embodiments, the mobile device 30 comprises a cellular phone of the driver 26 or another occupant of the vehicle 20. The mobile device 30 has global positioning system (GPS) capability that provides information regarding a position of the mobile device 30. The GPS capability of the mobile device 30 also provides relative range rate information that indicates a speed of movement of the mobile device 30.

The mobile device 30 is configured with a software application that enables the use of the relative range rate information from the mobile device 30 to be used in association with information from the imaging device 22, 28 to provide enhanced guidance to the driver 26.

In some embodiments, the output to the driver is provided on the user interface 24 while in other embodiments, the output to the driver 26 is provided on the mobile device 30. Depending which device is used for providing the driver output, a processor of the mobile device 30 or a processor associated with the user interface 24 utilizes information regarding the image from the imaging device 22, 28 and the indication of range rate information from the mobile device 30. The processor is configured to determine that there is at least one object in the vicinity of the vehicle based on the image information. The processor determines the speed of vehicle movement based on the range rate information. The processor determines relative movement between the vehicle and the object and the risk of collision between the vehicle and the object based on the determined speed and the determined relative movement. The driver output provided on the mobile device 30 or the user interface 24 includes a risk indication indicating the determined risk of collision to the driver 26. For example, when the processor determines that a collision with at least one object near the vehicle is likely to occur, a warning, such as a visible or audible indication, alerts the driver 26 to the collision risk.

In some example embodiments, a wireless communication link is established between the mobile device 30 and the components of the system 20 supported on the vehicle. The wireless link allows communication of the relative range rate information from the mobile device 30 to be incorporated into the determinations made by the driver assistance system 20. In other embodiments, the vehicle will include a docking station or line-based connector to establish a physical connection between the mobile device 30 and components of the driver assistance system 20 that are supported on the vehicle to allow communication between the mobile device 30 and such components.

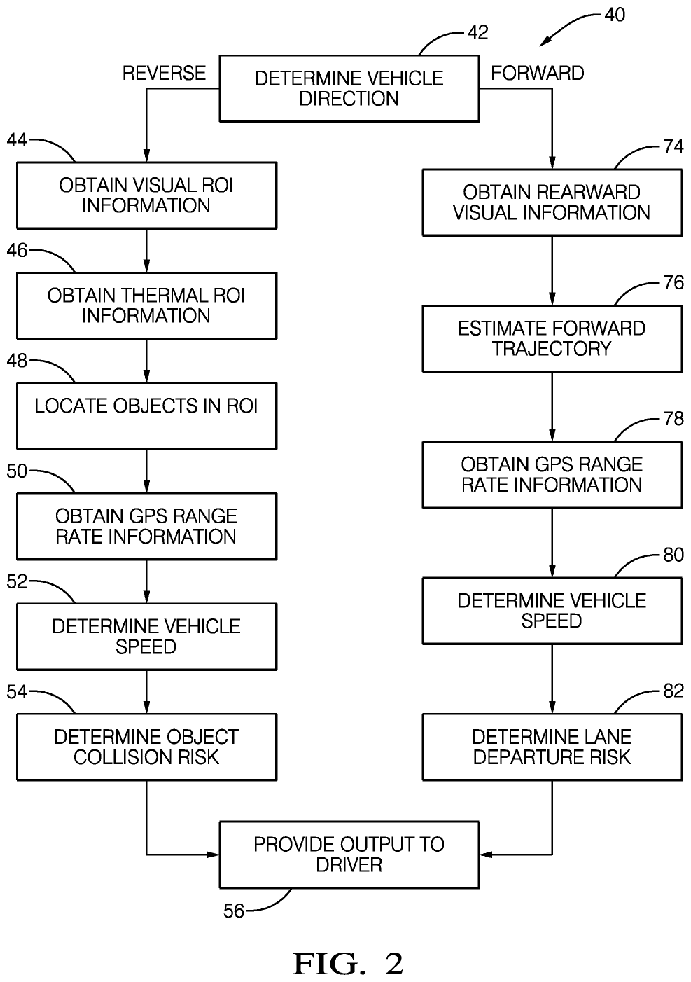

FIG. 2 includes a flowchart diagram 40 summarizing an example approach according to an embodiment. At 42, the processor of the vehicle assistance system 20 determines the direction of travel of the vehicle. This determination may be made, for example, by obtaining information from a vehicle transmission system that indicates whether the vehicle transmission is in reverse gear or a forward drive gear, for example. Other information available from known devices on a vehicle may be used to determine the direction of vehicle movement in some implementations.

If the vehicle is moving in reverse, the processor obtains information from the imaging device 22, 28 at 44. In this example, the imaging device comprises at least the visual camera 22 that provides visual region of interest (ROI) information, such as the area in the vicinity immediately behind the vehicle. In this example, at 46, the processor obtains thermal region of interest information from the thermal camera 28. At 48, the processor locates at least one object in the region of interest. The manner in which the processor detects objects from the image information in some embodiments is accomplished using known image processing techniques to recognize or detect an object within the image. The processor has the ability to recognize or determine a location of any such object within the area corresponding to the image information.

At 50, the processor obtains the GPS range rate information from the mobile device 30. At 52, the processor uses the range rate information to determine the vehicle speed of movement.

Given the information regarding the position of an object in the image, information regarding a trajectory of the vehicle, which may be obtained in a known way based on steering angle information that is available from known arrangements on vehicles and the determined speed, the processor determines an object collision risk at 54. According to an example embodiment, the processor determines a distance between an area of the image corresponding to the object location and another area of the image corresponding to the vehicle. A distance between those two areas may be obtained using known image pixel processing techniques for detecting or determining a distance between two areas in an image. With the incremental range rate information from the mobile device 30, the processor is able to determine the rate of movement or speed of the vehicle in an ongoing manner Based on the distance between the vehicle and an object, which is obtained from the image information, and the vehicle speed, the processor is able to determine a collision risk based on, for example, an amount of time that it will take the vehicle to reach the object at the current vehicle speed.

At 56, the vehicle assistance system 20 provides an output to the driver regarding the object collision risk. The output to the driver may take many forms and may be provided at different levels or in different manners. For example, an object collision risk may comprise a visual indication on a display screen and the visible indication may be different depending on how imminent a collision may be. Alternatively, the output may comprise an audible collision risk indicator, which may be different depending on the level of risk that a collision with an object is likely. For example, as the vehicle moves closer and closer to an object, the driver output may change in a manner that provides information to the driver that the risk of a collision with the object is increasing.

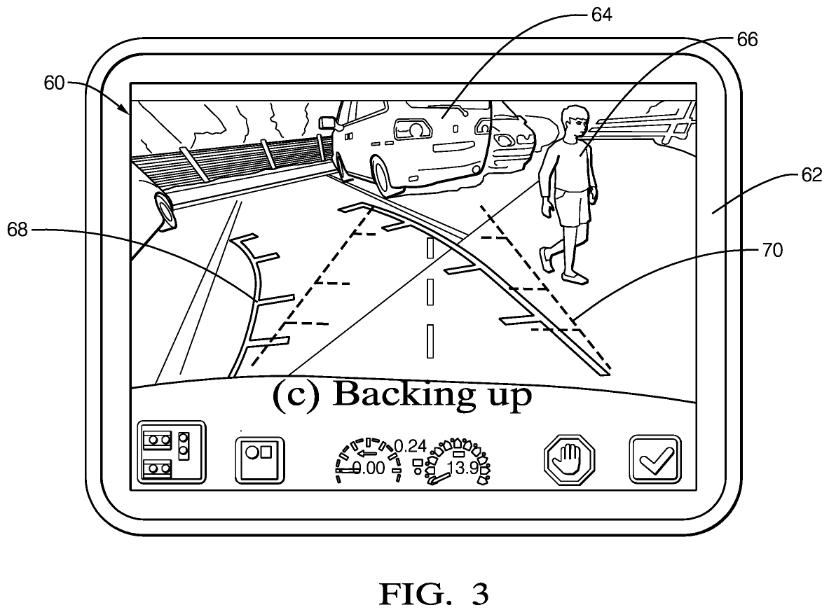

FIG. 3 illustrates an example output 60 provided on a display screen 62. The display screen 62 may be on the mobile device 30 or part of the user interface 24 supported in the vehicle. The driver assistance system 20 may be customized depending on the particular vehicle configuration. For example, when vehicles do not have sufficient display screen capability, the software application installed on the mobile device 30 is configured to utilize the display screen on the mobile device 30 to provide the output to the driver. Such embodiments allow for realizing the results of this invention even in vehicles that do not currently have backup camera capability with an onboard display to provide driver assistance without requiring a significant or expensive alteration to the vehicle or its on-board components.

The example driver output shown in FIG. 3 includes a visual image showing objects 64 and 66, which in this example are another vehicle and an individual, respectively. The driver output 60 also includes an indication of a trajectory of the vehicle at 68 and an indication of the space immediately behind the vehicle at 70. As can be appreciated from the illustration, the driver output display 60 provides information to a driver to assist in backing up the vehicle while avoiding contact with the objects 64 and 66.

Various ways of altering the display 60 including changing the color of one or more aspects of the display or causing a portion of the display to flash, may serve as the collision risk indicator. Some embodiments include adding a symbol or additional text to the displayed image as an indicator of a collision risk. Those skilled in the art who have the benefit of this description will be able to customize a collision risk indication to meet the needs of their particular situation.

Some embodiments include an ability to provide driver assistance when the vehicle is moving in a forward direction even if the only imaging device obtains information regarding the vicinity behind the vehicle. As shown in FIG. 2, when the processor determines at 42 that the vehicle is moving in a forward direction, the processor obtains rearward visual information at 74 from the imaging device 22. Based on information within such an image, the processor is able to estimate a forward trajectory at 76. Some embodiments include using information regarding a steering angle, for example, that is already available on a vehicle and useful for determining a forward trajectory.

At 78, the processor obtains the GPS range rate information from the mobile device 30 and determines a vehicle speed at 80 based on that range rate information.

In instances where the rearward visual information obtained at 74 provides an indication of lane markers, a travel lane is determined to be an intended pathway of the vehicle. For example, an expected direction of a vehicle travel lane may be extrapolated from information regarding lane markers within the obtained visual image. At 82, the processor uses the image information and the estimated trajectory along with the vehicle speed to determine a lane departure risk at 82. At 56, the output to the driver includes an indication of such a lane departure risk when one exists. In an example embodiment, known image processing and image content recognition techniques are used for recognizing objects or markers within the image for determining the intended pathway of the vehicle.

Utilizing the relative range rate information available from the GPS capabilities on the mobile device 30 allows for incorporating vehicle speed information into determinations based on image information regarding the vicinity of a vehicle for purposes of providing additional information to a driver without requiring additional hardware or altering the hardware on-board a vehicle. Instead, a software application installed on a mobile device that facilitates including GPS range rate information from that device in collision risk determinations provides a cost-effective and convenient enhancement to driver assistance.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A driver assistance system, comprising:
an imaging device configured to be mounted to a vehicle and to provide an image of a vicinity of the vehicle;
a mobile device that is configured to be carried by a driver, the mobile device having global position capability that provides at least an indication of range rate information regarding a change in position of the mobile device;
a processor that utilizes information regarding the image from the imaging device and the indication of range rate information from the mobile device to:
determine that there is at least one object in the vicinity of the vehicle based on the image,
determine a speed of vehicle movement based on the range rate information,
determine relative movement between the vehicle and the at least one object based on at least the image, and
determine a risk of collision between the vehicle and the at least one object based on the determined speed and the determined relative movement; and
a driver assist output that provides a risk indication of the determined risk of collision to the driver.

2. The driver assistance system of claim 1, wherein
the driver assist output comprises a display screen;
the display screen displays a representation of the image; and
the display screen provides a visual representation of the risk indication.

3. The driver assistance system of claim 2, wherein the mobile device comprises the display screen.

4. The driver assistance system of claim 3, wherein
the mobile device is configured with an application that allows the mobile device to receive the image from the imaging device; and
the mobile device comprises the processor.

5. The driver assistance system of claim 4, wherein the mobile device comprises a cellular phone.

6. The driver assistance system of claim 4, wherein the mobile device is configured to provide an audible output of the risk indication.

7. The driver assistance system of claim 2, comprising a user interface configured to be supported in the vehicle and wherein the user interface comprises the processor and the display screen.

8. The driver assistance system of claim 1, wherein
the image indicates a condition of the vicinity behind the vehicle;
the processor determines whether the vehicle is moving in a forward or reverse direction; and
if the vehicle is moving in the reverse direction, the processor determines a change in distance between the vehicle and the at least one object based on at least the determined speed of vehicle movement and a position of the at least one object in the image, or
if the vehicle is moving in the forward direction, the processor determines an intended pathway of the vehicle based on information from the image.

9. The driver assistance system of claim 8, wherein if the vehicle is moving in the forward direction, the processor
determines an intended pathway of the vehicle based on at least information from the image;
determines a trajectory of the vehicle relative to the intended pathway;
determines a risk that the vehicle will depart from the intended pathway based on the determined speed of vehicle movement and the determined trajectory; and
the driver output provides an indication to the driver regarding the determined risk that the vehicle will depart from the intended pathway.

10. The driver assistance system of claim 9, wherein
the intended pathway comprises a marked travel lane on a roadway; and
the driver output provides a warning that the vehicle is departing from the marked travel lane when the risk that the vehicle will depart from the intended pathway exists.

11. The driver assistance system of claim 1, wherein the imaging device comprises at least one of a visible image detector and a thermal image detector.

12. The driver assistance system of claim 1, wherein
the image comprises a plurality of pixels;
the processor determines the relative movement between the vehicle and the at least one object based changes in a quantity of pixels between a first area of the image corresponding to the vehicle and a second area of the image corresponding to the at least one object; and
the processor determines the risk of collision based on a current quantity of the pixels between the first and second areas of the image and the determined speed of vehicle movement.

13. A method of assisting a driver of a vehicle, the method comprising:
obtaining an image of a vicinity of the vehicle;
obtaining range rate information from a mobile device that is configured to be carried by the driver, the mobile device having global position system capability that provides at least an indication of range rate information regarding a change in position of the mobile device;
determining that there is at least one object in the vicinity of the vehicle based on the image;
determining a speed of vehicle movement based on the range rate information;
determining relative movement between the vehicle and the at least one object based on at least the image;
determining a risk of collision between the vehicle and the at least one object based on the determined speed and the determined relative movement; and
providing a risk indication of the determined risk of collision to the driver.

14. The method of claim 13, comprising
displaying a representation of the image on a display screen; and
providing the risk indication as a visible indication on the display screen.

15. The method of claim 14, wherein the mobile device comprises the display screen.

16. The method of claim 15, wherein the mobile device comprises a cellular phone.

17. The method of claim 4, wherein the mobile device is configured to provide an audible output of the risk indication.

18. The method of claim 13, wherein the image indicates a condition of the vicinity behind the vehicle and the method comprises determining whether the vehicle is moving in a forward or reverse direction; and
if the vehicle is moving in the reverse direction, determining a change in distance between the vehicle and the at least one object based on at least the determined speed of vehicle movement and a position of the at least one object in the image, or
if the vehicle is moving in the forward direction, determining an intended pathway of the vehicle based on information from the image, determining a trajectory of the vehicle relative to the intended pathway, determining a risk that the vehicle will depart from the intended pathway based on the determined speed and the determined trajectory, and
providing an indication to the driver regarding the determined risk that the vehicle will depart from the intended pathway.

19. The method of claim 18, wherein
the intended pathway comprises a marked travel lane on a roadway; and
the indication to the driver provides a warning regarding the vehicle departing from the marked travel lane when the risk that the vehicle will depart from the intended pathway exists.

20. The method of claim 13, wherein the image comprises a
plurality of pixels and the method comprises
determining the relative movement between the vehicle and the at least one object based changes in a quantity of pixels between a first area of the image corresponding to the vehicle and a second area of the image corresponding to the at least one object; and
determining the risk of collision based on a current quantity of the pixels between the first and second areas of the image and the determined speed of vehicle movement.
